(19) United States
(12) Patent Application Publication
(10) Pub. No.: US 2024/0293896 A1
(43) Pub. Date: Sep. 5, 2024

(54) METHOD FOR THE CREATION OF DECORATIONS AND/OR LOGOS ON MATERIALS MADE OF METAL, PREFERABLY BUT NOT EXCLUSIVELY FOR PARTS OF EYEGLASSES AND THE LIKE

(71) Applicant: LUXOTTICA S.R.L., Agordo (IT)

(72) Inventors: Filippo BONFARNUZZO, San Vendemiano (IT); Davide GECHERLE, Milano (IT); Alessandro DONOLI, Agordo (IT)

(21) Appl. No.: 18/258,888

(22) PCT Filed: Dec. 16, 2021
(86) PCT No.: PCT/EP2021/086230

§ 371 Date: Jun. 22, 2023

(30) Foreign Application Priority Data
Dec. 22, 2020 (IT) 102020000031808

(51) Int. Cl. B23K 26/364; B23K 26/0622; B23K 26/352; C25D 3/04; C25D 3/48; C25D 5/00; C25D 5/50

(52) U.S. Cl. CPC B23K 26/364; B23K 26/0624; C25D 3/04; C25D 3/48; C25D 5/50; C25D 5/627; B23K 26/352

(57) ABSTRACT

A method for the creation of decorations and/or logos on materials made of metal, preferably but not exclusively for parts of eyeglasses and the like, which includes the steps of starting from a substrate made at least partly of a metallic material, performing a first galvanic deposition and a second galvanic deposition, depositing a first and a second layer of material on the substrate, wherein at least one material of the first and second galvanic depositions is a precious metal; and removing at least partially the surface layer that derives from the second galvanic deposition, leaving the underlying layer that derives from the first galvanic deposition substantially unchanged, so as to form a groove. The the groove has a substantially constant depth along its entire extension.

### CROSS-REFERENCE TO RELATED APPLICATIONS

This application is a 35 U.S.C. § 371 National Stage patent application of PCT/EP2021/086230 filed 16 Dec. 2021, which claims the benefit of Italian patent application 102020000031808 filed 22 Dec. 2020, the disclosures of which are incorporated herein by reference in their entirety.

### TECHNICAL FIELD

The present disclosure relates to a method for the creation of decorations and/or logos on materials made of metal, preferably but not exclusively for parts of eyeglasses and the like.

More specifically, the disclosure relates to a method for providing decorations and/or logos on temples or fronts of eyeglasses.

### BACKGROUND

Methods are known in the state of the art for providing decorations on metal, for example in watchmaking and jewelry, in which laser cutting is used to work parts of the metallic surface, via the interposition of a protective layer, in order to create different decorative motifs.

Methods are also known in the state of the art for providing decorations on plastic, through thermal transfer activated by a laser in order to inhibit the galvanic deposition in selected zones on the surface of the plastic material which bear the decoration.

### SUMMARY

The aim of the present disclosure is to provide a method for the creation of decorations and/or logos on materials made of metal, preferably but not exclusively for parts of eyeglasses and the like, that makes it possible to obtain a particular decorative and coloring effect.

Within this aim, an of the present disclosure provides a method for the creation of decorations and/or logos that makes it possible to highlight such decorations and/or logos with visual contrast.
the present disclosure also provides a method that is highly reliable, simple to provide and of low cost.

This aim and these and other advantages which will become better apparent hereinafter are achieved by providing a method for the creation of decorations and/or logos on materials made of metal, preferably but not exclusively for parts of eyeglasses and the like, which is characterized in that it comprises the steps of:
starting from a substrate made at least partly of a metallic material, performing a first galvanic deposition and a second galvanic deposition, depositing a first and a second layer of material on the substrate, wherein at least one material of the first and second galvanic depositions is a precious metal;
removing at least partially the surface layer that derives from the second galvanic deposition, leaving the underlying layer that derives from the first galvanic deposition substantially unchanged, so as to form a groove;
said groove having a substantially constant depth along its entire extension.

### BRIEF DESCRIPTION OF THE DRAWINGS

Further characteristics and advantages of the disclosure will become better apparent from the description of a preferred, but not exclusive, embodiment of the method according to the disclosure, which is illustrated by way of non-limiting example in the accompanying drawings wherein:

FIGS. 1-5 show the sequence of steps of the method according to the disclosure.

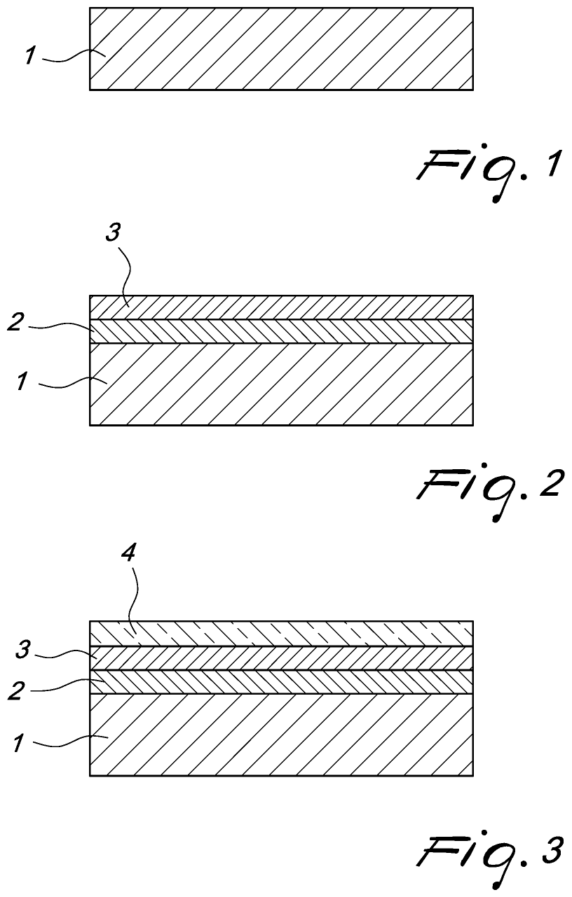

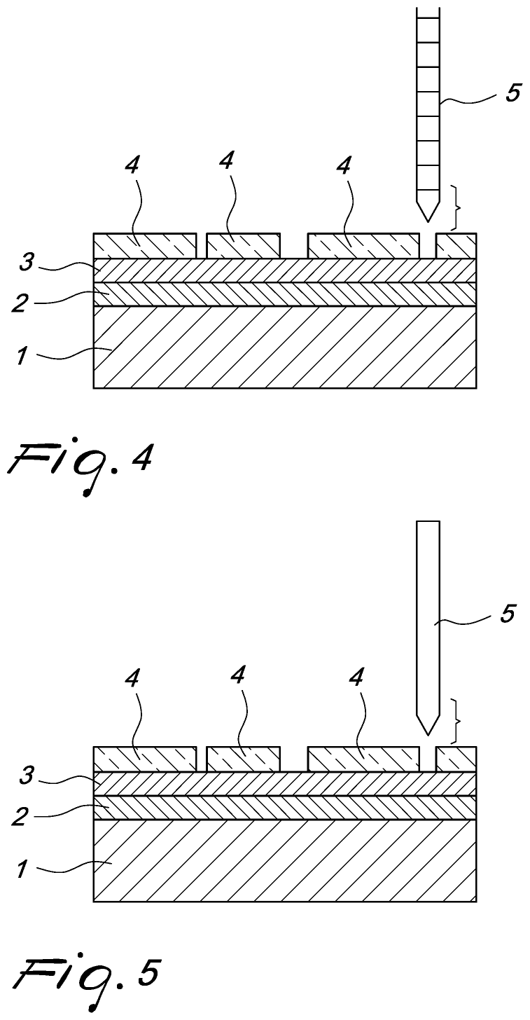

### DETAILED DESCRIPTION OF THE DRAWINGS

With reference to the figures, the method according to the disclosure comprises, starting for example from a temple or front of an eyeglasses frame, or parts thereof (for example, the core) made at least partially of a metallic material, such as for example steel, nickel silver or the like, bronze or monel, which are indicated in the figures by the reference numeral 1, the following steps.

Firstly, starting therefore from a substrate 1 of metallic material (for example steel, nickel silver, bronze or monel) that constitutes for example a temple or front of an eyeglasses frame, or parts thereof, a first step is optionally carried out of deposition of a layer of nickel or of white bronze 2 on the substrate 1, followed by a first galvanic deposition (electroplating) which makes it possible to deposit a layer 3 of precious metal such as for example gold or another precious metal.

At this point there is a second galvanic deposition of an additional layer 4, for example of chromium, on the previously-deposited layer 3.

In substance, at least one of the two galvanic depositions must be with a material made of precious metal. The precious metal can be, by way of example: gold, rose gold, palladium or chromium.

Furthermore, the two deposited layers of metal must be, preferably, in contrasting colors so as to emphasize the chromatic effect of the decoration.

Subsequently, the layer of material 4 deposited through the second galvanic deposition is selectively subjected to ablation, for example using an ultrafast pulsed laser 5, such as by way of example a femtosecond laser or a picosecond laser, and with removal of a constant quantity of material for the depth of the groove.

There follows a step of laser polishing of the layer 3 that was exposed after the step of laser removal.

This makes it possible to have a decoration and/or logo defined by a groove that has a constant depth and therefore an excellent visual and aesthetic result.

In order to obtain a better chromatic effect, the two galvanic depositions must be in contrasting colors (for example one of silver and the other of rose gold, or silver with gunmetal chromium). This is in order to exalt the visual contrast deriving from the chromatic combination.

The laser technology used is such as to completely inhibit the propagation of heat outside the treated area, i.e. there is no area that is affected by the heat of the laser 5 used for the step of ablation.

The method described makes it possible to remove, using the laser 5, at least some of the superficial galvanic deposition (upper layer 4), while leaving the underlying galvanic deposition (lower layer 3) substantially unaltered.

In this manner a particular color effect is obtained and the decoration and/or the logo are noticeable to the eye, defined as incisions in the upper layer 4.

The method thus conceived is susceptible of numerous modifications and variations, all of which are within the scope of the appended claims.

Moreover, all the details may be substituted by other, technically equivalent elements.

In practice, the materials used, as well as the contingent shapes and dimensions, may be any according to the requirements and to the state of the art.

1-7. (canceled)

8. A method for the creation of decorations and/or logos on materials made of metal, the method including the following steps:
starting from a substrate made at least partly of a metallic material, performing a first galvanic deposition and a second galvanic deposition, depositing a first and a second layer of material on said substrate, wherein at least one material of the first and second galvanic depositions is a precious metal, and
removing at least partially the surface layer that derives from the second galvanic deposition, leaving the underlying layer that derives from the first galvanic deposition substantially unchanged, so as to form a groove,
said groove having a substantially constant depth along an entire extension thereof.

9. The method according to claim 8, wherein said first and second galvanic depositions are in contrasting colors.

10. The method according to claim 8, wherein said step of at least partial removal of the layer that derives from said second galvanic deposition is performed by laser removal.

11. The method according to claim 10, wherein said laser removal step is performed with a femtosecond or picosecond laser and with removal of a constant quantity of material for the depth of the groove.

12. The method according to claim 8, further comprising, prior to the first and second galvanic depositions, a step of deposition of a layer of nickel or white bronze on said substrate.

13. The method according to claim 8, wherein said precious metal is gold, rose gold, palladium, or chromium.

14. The method according to claim 10, further comprising, after the step of at least partial removal of the layer that derives from said second galvanic deposition, a step of laser polishing of said layer of said first galvanic deposition which is exposed as a consequence of said laser removal.
